(19) United States
(12) Patent Application Publication
(10) Pub. No.: US 2012/0078695 A1
(43) Pub. Date: Mar. 29, 2012

(54) Universal Bonus/Rewards Card

(76) Inventor: Alexander Thomas Paterson, Indiana, PA (US)

(21) Appl. No.: 13/226,776

(22) Filed: Sep. 7, 2011

Related U.S. Application Data
(60) Provisional application No. 61/404,104, filed on Sep. 27, 2010.

(51) Int. Cl. G06Q 30/00

(52) U.S. Cl. 705/14.15; 705/14.3

(57) ABSTRACT

A universal rewards system for consolidating reward and bonus programs across a series of programs in which a consumer participates. The system includes at least one computer having a computer-readable medium with program instructions stored thereon to cause the processor to receive data streams regarding participating merchants, determine and/or identify qualified transactions, identify appropriate rewards/bonuses, and identify participating consumers, generate data regarding the qualified transactions and the appropriate rewards/bonuses, and transmit information regarding the qualified transactions and issuance of the appropriate rewards/bonuses. The system also includes an identification device for distribution to the participating consumers. The identification device is a single device, eliminating the need for the consumer to carry a multitude of identification devices, that includes identifying information unique to the participating consumer, is configured for universal acceptance by each of the participating merchants and, wherein at least some of the participating merchants offer diverse goods and/or services.

### CROSS REFERENCE TO RELATED APPLICATIONS

This application is based on and claims priority to Provisional Patent Application No. 61/404,104, entitled Universal Bonus/Rewards Card, filed Sep. 27, 2010, which is herewith incorporated by reference in its entirety.

### BACKGROUND OF THE INVENTION

1. Field of the Invention

This invention relates to a universal bonus or universal rewards system for tracking and rewarding a consumer's purchases and, more particularly, to a universal bonus or rewards system that simplifies a rewards system making it easier for the consumer to use and manage, provides the merchant running the reward system a means to offset transaction fees and the cost of providing the rewards, reduces merchant advertising fees, and promotes a green economy through the replacement of paper based advertising with a computer platform.

2. Description of Related Art

In the United States, approximately 73% of all families now carry a credit card, with 78% of those credit card wielding households having one or more credit card. By some estimates, there are somewhere between 610 million and 1.4 billion credit cards in circulation among 181 million credit card carrying individuals in the United States. This staggering volume of plastic translates into an average upwards of 7.7 cards per credit-toting individual. While many card types exist (such as bank-type cards, store cards, and gasoline cards) usage data shows that average monthly spending on credit cards is nearly double among cards tied to loyalty systems. Therefore, loyalty based systems are attractive to businesses to encourage customer participation among various promotions.

Loyalty systems, such as rewards programs, were developed largely to influence consumer behavior, for example, by encouraging increased or targeted spending. Conventional loyalty systems often permit the accumulation of loyalty points, where the consumer can redeem loyalty points in various ways, including exchanging the loyalty points for various goods and services. For example, typical rewards may be selected from a merchant-approved list or a merchant redemption catalog. Well-known examples of merchant-based affinity systems include Best Buy's Reward Zone Program, Dick's Sporting Good's ScoreCard®, and Starbuck's My Starbucks Rewards.

While loyalty systems can offer many benefits for both the consumer and the merchant, there are also drawbacks. For instance, consumers who wish to participate in multiple programs typically must enroll separately per merchant for which they are generally issued an identifying instrument such as a rewards program card or key fob. These instruments can be overly cumulative as customers who enroll in multiple rewards programs are often burdened by carrying many such instruments in their wallets or on upon their key rings. This is further complicated by the need to adhere to the rules and restrictions associated with each program.

Loyalty systems can also include credit systems that are tied to a particular method of payment, such as credit cards. For example, affinity based systems permit an organization to offer participants a credit card that promotes the organization's brand and imagery each time a cardholder uses the card. An affinity credit card program may pay the brand-owning organization a bonus for each new account generated, plus a percentage of every transaction charged to the card. Affinity credit cards are often offered by retailers, shopping centers, airlines, hotels, universities, alumni associations, sports teams, professional associations and others, and increasingly by small and mid-sized nonprofits and membership-based groups that rely on these programs for incremental revenue. Specific examples include the Membership Rewards® Program of American Express and the TruEarning® from Costco and American Express.

Despite the success of loyalty credit systems, the card industry is continually changing, seeking new sources of growth among changing markets and legislation. Further, the costs of doing business remain great. At present, nearly all processing fees are passed onto merchants. This can often make certain systems less desirable to merchants. In an effort to divert processing costs, some issuers often prefer working with large organizations that allow direct access to members. This provides the issuer with access to members for the purpose of cross-marketing credit cards and other financial products. Alternatively, some other issuers may charge consumers membership fees for use of their product, often in consideration for rewards programs. Nevertheless, a need exists for credit card companies to increase revenues as well as the attractiveness of their systems and products, to consumers and merchants alike.

Both loyalty and affinity based systems can also provide merchants or affiliates with information to distribute coupons, promotional information, and/or vouchers. Like rewards program card and key fob instruments, consumers may need to physically carry many coupons, etc. to take full advantage of loyalty programs. This is often inconvenient for the consumer and is also wasteful in an increasingly green economy, especially since the majority of paper-based coupons and vouchers are rarely ever redeemed.

Consumers may typically receive, for example, by mail, numerous coupon booklets, newspapers, rebate checks, and envelopes full of post card advertisements. Oftentimes, the consumer will not review the entire packet of promotions. Instead, the consumer will simply toss the entirety of the mailer away, without even reviewing its contents. If the consumer spends the time reviewing the various promotions, the consumer may only select a very small subset of promotions to save for later use. The consumer will often save the few promotions in a drawer or folder which usually causes the consumer to forget about the promotions, at least until the promotional period has expired. Moreover, the sponsors of these promotions often do not have an adequate method for monitoring, tracking and analyzing the success of their promotions. For example, promotions may be passed or shared among consumers, likely misleading the distributor about the effect of the promotion upon the target recipient group. Furthermore, in some situations, the consumer may unethically attempt to copy or reproduce the promotion in order to wrongly obtain repeated benefits from the promotion. As such, a need exists for an improved system and method for distributing a voucher to consumers, which can result in increased use of the vouchers and decreased fraudulent use.

Existing systems also raise security concerns. Customers are usually required to divulge personal information with each enrollment application, which can be inconvenient and potentially subject a consumer to unwanted physical and electronic mailings or even identification theft. Additionally, aging technologies are prone to identity theft. For example, magnetic strip technologies are easily copied by identity thieves, permitting generations of bogus cards that can be used at automated teller machines or otherwise. Since the success of these systems relies heavily upon the ability to securely exchange transactional and behavioral information, there is a need to adopt more accessible, efficient, and reliable systems.

Examples of known loyalty based systems include US 2010/0274659, which is directed to the conversion of loyalty points to merchant-specific loyalty dollars. The resulting system and method help reduce the need to carry multiple promotional material or vouchers. Other systems such as US 2007/0038515, U.S. Pat. No. 7,765,124 B2, U.S. Pat. No. 7,769,630 B2, and U.S. Pat. No. 7,742,943 B2 process transaction information between merchants and acquiring banks to aid in the distribution of loyalty or reward points, by utilizing conventional credit card infrastructure.

It remains that a need exists for a more efficient universal system, which can divert ever mounting merchant costs, while effectively collecting consumer information and while improving the direct distribution of targeted mailers and vouchers that are desirable to consumers, keeping in mind the need for a green economy. Moreover, a need exists that allows consumers to have better access to the universal system (e.g., using a mobile electronic device), giving the consumer the ability to effectively manage information across all programs in which the consumer participates.

### SUMMARY OF THE INVENTION

According to a first aspect, the invention is directed to a universal rewards system for consolidating reward and bonus programs across a series of programs in which a consumer participates. The system comprises at least one computer having a computer-readable medium with program instructions stored thereon, which, when executed by a processor of the at least one computer, causes the processor to directly or indirectly receive data streams or notifications regarding participating merchants, identify qualified transactions, identify appropriate rewards/bonuses; and identify participating consumers; determine and/or generate data regarding the qualified transactions and the appropriate rewards/bonuses; and transmit information regarding the qualified transactions and issuance of the appropriate rewards/bonuses. Each participating merchant can have a computer interconnected with the processor for supplying at least some of the data streams or information. The system also includes an identification device for distribution to the participating consumers. This identification device includes identifying information unique to the participating consumer and is configured for universal acceptance by each of the participating merchants, and wherein at least some of the participating merchants offer diverse goods and/or services.

The identification device can comprise a card, a key fob, a phone application, and/or any other type of computer readable device. Receipt of the identification device can require payment of a participation or membership fee in order to assist the merchant in recouping the cost of providing the identification device and/or to offset the costs associated with the bonus or reward for participating in the rewards system. Also, use of the identification device by the consumer can incur a minimal swipe fee associated with each transaction to also help offset the costs to the merchant. Swiping of the identification device will result in crediting or redeeming any reward or bonus.

The processor is capable of receiving data streams, including advertising information, from the participating merchants, and transmitting this information to the participating consumers, in real time, eliminating the costs associated with printing and mailing advertisements and promoting a green economy. The advertising information can include merchant flyers and coupons, daily specials or clearance or bargain items. The participating merchants can be charged an additional fee in order to have a special advertisement section on a website operated by the processor to advertise the clearance or bargain items as a way to unload extra inventory, overstocked items, or hard to sell items. Use of the identification device can result in automatic redemption of any store specials or coupons currently advertised.

The processor can be tied to national or brand coupon manufacturers and can be capable of receiving data streams regarding coupons and specials offered by the national or brand coupon manufacturers. The national or brand coupon manufacturers can pay a fee to advertise on a website associated with the processor and to have their items recognized by the identification device and discounted the amount of the coupon upon purchase. The processor can be configured to automatically tally the discounts due to the participating merchants for these coupons and specials; transmit this information to the manufacturer or a clearing house for redemption from the manufacturer, and transmit any monies owed to the participating merchants for coupons redeemed by participating consumers. The fee paid by the national or brand coupon manufacturer can include advertising media, such as a placard, that is given to all of the participating merchants for the particular item for which a coupon or discount is available, and that merchant can display this media in their store. Use of the identification device results in automatic redemption to the consumer of any brand manufacturer's coupons participating in the universal reward system.

The identification device can be linked to a participating consumer's credit card or bank account information so that use of the identification device allows access to the participating consumers account information for automatic payment of a purchased good or item. This would eliminate the need for the participating consumer to carry a separate credit card or bank card.

The processor can also be configured to directly transmit information to participating consumers to enable them to receive real time electronic notification of merchant flyers, coupons, sale notices, and advertisements from participating merchants. This electronic notification can be through a website operated by the processor, email communications, text messages, social media such as Facebook notifications, and the like. The processor can also be configured to allow the participating consumers to communicate with the processor to select or deselect certain participating merchants from which to receive the electronic notifications.

The processor can enable a merchant's computer to determine and/or generate data regarding spending habits of the participating consumer for targeted advertising, determine and/or generate data purchased prescriptions and refill due dates, determine and/or generate data regarding recall notices on purchased items, and determine and/or generate data regarding update information for any purchased items.

According to another aspect, the invention is directed to a computer-implemented method for a universal rewards program for consolidating reward and bonus programs across a series of programs in which a consumer participates. The method comprises providing at least one computer having a computer-readable medium with program instructions stored thereon, which, when executed by a processor of the at least one computer, cause the processor to directly or indirectly receive data streams or notifications regarding participating merchants, identify qualified transactions, identify appropriate rewards/bonuses; and identify participating consumers; determine and/or generate data regarding the qualified transactions and the appropriate rewards/bonuses; and transmit information regarding the qualified transactions and issuance of the appropriate rewards/bonuses. The method further includes providing information to the processor wherein the information includes participating merchants, qualified transactions, appropriate rewards/bonuses and participating consumers; and providing an identification device for distribution to the participating consumers. The identification device includes identifying information unique to the participating consumer and is configured for universal acceptance by each of the participating merchants and wherein at least some of the participating merchants offer diverse goods and/or services.

The method can also include charging a participation fee to the participating merchants and charging membership dues and swipe fees to the participating consumers to offset any participation fees and costs associated with the rewards program. The method includes allowing the merchant to provide information to the processor regarding store specials, store flyers, and product and/or service coupons and the processor is configured for transmitting this information to the participating consumers. The processor can be configured to receive data from national or brand coupon manufacturers, gather and tally information regarding the redeemed coupons, transmit this information to the national or brand coupon manufactures for redemption of any monies owed to the participating merchants for coupons redeemed by participating consumers, and transmitting any owed monies to the participating merchants. Use of the identification device results in automatic redemption of any brand manufacturer's coupons participating in the universal reward system. The processor can be configured to directly transmit information to participating consumers to enable them to receive electronic notification of merchant flyers, coupons, sale notices, and advertisements from participating merchants.

According to yet another aspect, the invention is directed to an apparatus for operating a universal rewards program for consolidating reward and bonus programs across a series of programs in which a consumer participates. The apparatus comprises at least one computer having a computer-readable medium with program instructions stored thereon, which, when executed by a processor of the at least one computer, cause the processor to directly or indirectly receive data streams or notifications regarding participating merchants, identify qualified transactions, identify appropriate rewards/bonuses; and identify participating consumers; determine and/or generate data regarding the qualified transactions and the appropriate rewards/bonuses; and transmit information regarding the qualified transactions and issuance of the appropriate rewards/bonuses. The apparatus further includes means for providing information to the processor wherein this information includes participating merchants, qualified transactions, appropriate rewards/bonuses and participating consumers. The apparatus also includes an identification device for distribution to the participating consumers. The identification device includes identifying information unique to the participating consumer and is configured for universal acceptance by each of the participating merchants. At least some of the participating merchants offer diverse goods and/or services.

The merchant subscription can provide the merchant with the opportunity to advertise on a website run by the computer-based platform. The merchant will be able to advertise their flyers, coupons, sales, and the like, eliminating the costs associated with printing and mailing advertisements and promoting a green economy. The participating consumers will have access to the website to view the advertisements, sales and coupons. According to one embodiment, the computer-based platform can be tied to national or brand coupon manufacturers. The computer-based platform can be programmed to automatically tally the coupons and send them to the manufacturer or a clearing house for redemption from the manufacturer and to subsequently refund any monies owed to the subscribing merchants for coupons redeemed by participating consumers. The rewards program can be designed such that use of the identification device results in automatic redemption of any store specials or coupons currently being advertised on the computer-based platform. According to another embodiment, the identification device can be linked to a credit card company wherein the identification device can also function as a credit card.

The computer-based platform can also include an e-mail or text option to enable the participating consumers to receive real time electronic notification of merchant flyers, coupons, sale notices, and advertisements. The system can also include an option for the participating consumer to select or deselect certain subscribing merchants listed on the computer-based platform to determine which merchants they would like to receive the electronic notifications. Some of the options that can be accomplished with the computer-based platform include the tracking of spending habits of the participating consumers allowing the merchant to target or customize their advertising, track purchased prescriptions and refill due dates, issue recall notices on purchased items, and issue update information for any purchased items. According to a further feature, the identification device can be linked to a personal banking account or credit card account of the participating consumer eliminating the need for the consumer to carry a separate bank card.

According to another aspect, the invention is directed to a method of operating a universal rewards program for consolidating reward and bonus programs across a series of programs in which a consumer participates. The method includes providing a computer-based platform for organizing and managing the universal rewards program and offering subscriptions to merchants to participate in the universal rewards program. The subscriptions to the merchants allow the merchants to access the computer-based platform and participate in the universal rewards program. The merchants can vary, offering diverse goods and/or services and, wherein the universal card is accepted by all of the subscribing merchants, and wherein each of the plurality of merchants offer a reward or bonus to a participating consumer upon a qualifying transaction for a good and/or service. The method also includes providing a computer-based network for interconnecting the plurality of subscribing merchants with each other and with the computer-based platform and issuing an identification device to the participating consumer. The identification device is configured for universal acceptance by each of the subscribing merchants and for gathering and/or issuing the reward or bonus with each qualifying transaction by the participating consumer.

These and other features and characteristics of the present invention, as well as the methods of operation and functions of the related elements of structures and the combination of parts and economies of manufacture, will become more apparent upon consideration of the following description with reference to the accompanying drawings, all of which form a part of this specification, wherein like reference numerals designate corresponding parts in the various figures.

### BRIEF DESCRIPTION OF THE DRAWINGS

FIG. 1 is a schematic view of a computing system and environment according to the prior art;

FIG. 2 is a block diagram illustrating the universal rewards system of the invention; and

FIG. 3 is a block diagram illustrating the various capabilities of the computer-based system of the invention.

### BRIEF DESCRIPTION OF THE INVENTION

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

It is to be understood that the invention may assume various alternative variations and step sequences, except where expressly specified to the contrary. It is also to be understood that the specific devices and processes illustrated in the attached drawings, and described in the following specification, are simply exemplary embodiments of the invention.

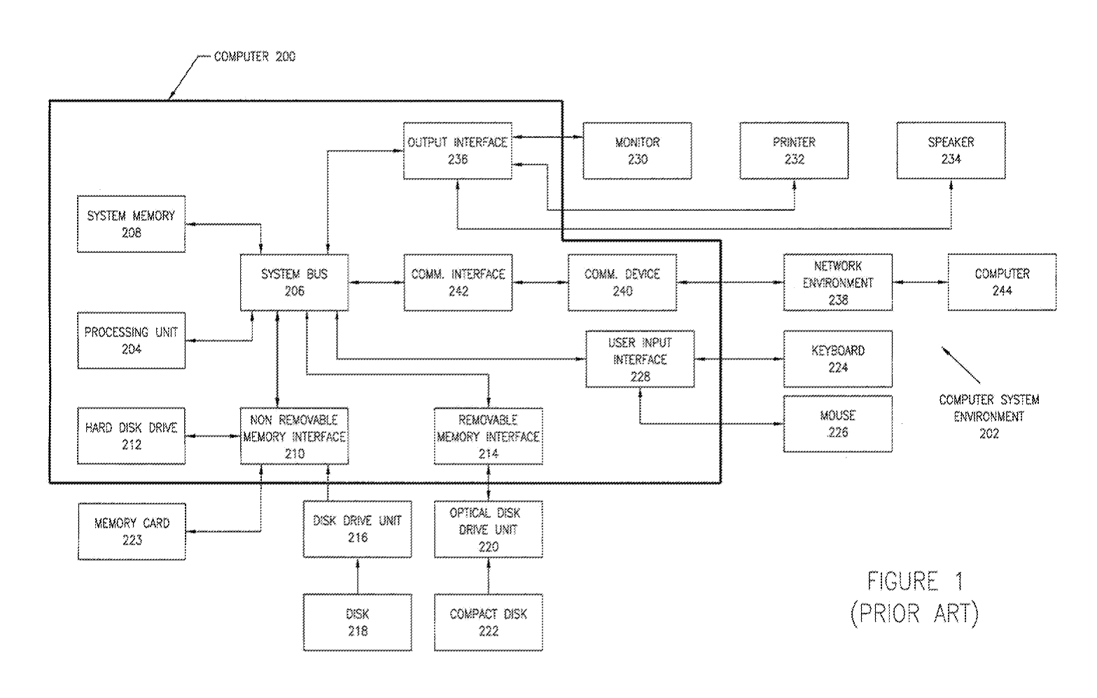

The present invention may be implemented on a variety of computing devices and systems, wherein these computing devices include the appropriate processing mechanisms and computer-readable media for storing and executing computer-readable instructions, such as programming instructions, code, and the like. As illustrated in FIG. 1 and according to the prior art, a schematic and block diagram of exemplary computing devices, in the form of personal computers 200, 244, in a computing system environment 202 are provided. This computing system environment 202 may include, but is not limited to, at least one computer 200 having certain components for appropriate operation, execution of code, and creation and communication of data. For example, the computer 200 includes a processing unit 204 (typically referred to as a central processing unit or CPU) that serves to execute computer-based instructions received in the appropriate data form and format. Further, this processing unit 204 may be in the form of multiple processors executing code in series, in parallel, or in any other manner for appropriate implementation of the computer-based instructions.

In order to facilitate appropriate data communication and processing information between the various components of the computer 200, a system bus 206 is utilized. The system bus 206 may be any of several types of bus structures, including a memory bus or memory controller, a peripheral bus, or a local bus using any of a variety of bus architectures. In particular, the system bus 206 facilitates data and information communication between the various components (whether internal or external to the computer 200) through a variety of interfaces, as discussed hereinafter.

The computer 200 may include a variety of discrete computer-readable media components. For example, this computer-readable media may include any media that can be accessed by the computer 200, such as volatile media, non-volatile media, removable media, non-removable media, etc. As a further example, this computer-readable media may include computer storage media, such as media implemented in any method or technology for storage of information such as computer-readable instructions, data structures, program modules, or other data, random access memory (RAM), read only memory (ROM), electrically erasable programmable read only memory (EEPROM), flash memory, or other memory technology, CD-ROM, digital versatile disks (DVDs), or other optical disk storage, magnetic cassettes, magnetic tape, magnetic disk storage, or other magnetic storage devices, or any other medium which can be used to store the desired information and which can be accessed by the computer 200. Further, this computer-readable media may include communications media, such as computer-readable instructions, data structures, program modules, or other data in a modulated data signal such as a carrier wave or other transport mechanism and include any information delivery media, wired media (such as a wired network and a direct-wired connection), and wireless media (such as acoustic signals, radio frequency signals, optical signals, infrared signals, biometric signals, bar code signals, etc.). Of course, combinations of any of the above should also be included within the scope of computer-readable media.

The computer 200 further includes a system memory 208 with computer storage media in the form of volatile and non-volatile memory, such as ROM and RAM. A basic input/output system (BIOS) with appropriate computer-based routines assists in transferring information between components within the computer 200 and is normally stored in ROM. The RAM portion of the system memory 208 typically contains data and program modules that are immediately accessible to or presently being operated on by processing unit 204, e.g., an operating system, application programming interfaces, application programs, program modules, program data, and other instruction-based computer-readable code.

The computer 200 may also include other removable or non-removable, volatile or non-volatile computer storage media products. For example, the computer 200 may include a non-removable memory interface 210 that communicates with and controls a hard disk drive 212, i.e., a non-removable, non-volatile magnetic medium; and a removable, non-volatile memory interface 214 that communicates with and controls a magnetic disk drive unit 216 (which reads from and writes to a removable, non-volatile magnetic disk 218), an optical disk drive unit 220 (which reads from and writes to a removable, non-volatile optical disk, such as a CD ROM 222), a Universal Serial Bus (USB) port for use in connection with a removable memory card 223, etc. However, it is envisioned that other removable or non-removable, volatile or non-volatile computer storage media can be used in the exemplary computing system environment 202, including, but not limited to, magnetic tape cassettes, DVDs, digital video tape, solid state RAM, solid state ROM, etc. These various removable or non-removable, volatile or non-volatile magnetic media are in communication with the processing unit 204 and other components of the computer 200 via the system bus 206. The drives and their associated computer storage media discussed above and illustrated in FIG. 1 provide storage of operating systems, computer-readable instructions, application programs, data structures, program modules, program data, and other instruction-based computer-readable code for the computer 200 (whether duplicative or not of the information and data in the system memory 208).

A user may enter commands, information, and data into the computer 200 through certain attachable or operable input devices, such as a keyboard 224, a mouse 226, etc., via a user input interface 228. Of course, a variety of such input devices may be utilized, e.g., a microphone, a trackball, a joystick, a touchpad, a touch-screen, a scanner, etc., including any arrangement that facilitates the input of data and information to the computer 200 from an outside source. As discussed, these and other input devices are often connected to the processing unit 204 through the user input interface 228 coupled to the system bus 206, but may be connected by other interface and bus structures, such as a parallel port, game port, or a USB. Still further, data and information can be presented or provided to a user in an intelligible form or format through certain output devices, such as a monitor 230 (to visually display this information and data in electronic form), a printer 232 (to physically display this information and data in print form), a speaker 234 (to audibly present this information and data in audible form), etc. All of these devices are in communication with the computer 200 through an output interface 236 coupled to the system bus 206. It is envisioned that any such peripheral output devices be used to provide information and data to the user.

The computer 200 may operate in a network environment 238 through the use of a communications device 240, which is integral to the computer or remote therefrom. This communications device 240 is operable by and in communication with the other components of the computer 200 through a communications interface 242. Using such an arrangement, the computer 200 may connect with, or otherwise communicate with, one or more remote computers, such as a remote computer 244, which may be a personal computer, a server, a router, a network personal computer, a peer device, or other common network node, and typically includes many or all of the components described above in connection with the computer 200. Using appropriate communications devices 240, e.g., a modem, a network interface, or adapter, etc., the computer 200 may operate within and communicate through a local area network (LAN) and a wide area network (WAN), but may also include other networks such as a virtual private network (VPN), an office network, an enterprise network, an intranet, the Internet, etc. It will be appreciated that the network connections shown are exemplary and other means of establishing a communications link between the computers 200, 244 may be used.

As used herein, the computer 200 includes or is operable to execute appropriate custom-designed or conventional software to perform and implement the processing steps of the method and system of the present invention, thereby forming a specialized and particular computing system. Accordingly, the presently-invented method and system may include one or more computers 200 or similar computing devices having a computer-readable storage medium capable of storing computer-readable program code or instructions that cause the processing unit 204 to execute, configure, or otherwise implement the methods, processes, and transformational data manipulations discussed hereinafter in connection with the present invention. Still further, the computer 200 may be in the form of a personal computer, a personal digital assistant, a portable computer, a laptop, a palmtop, a mobile device, a mobile telephone, a server, or any other type of computing device having the necessary processing hardware to appropriately process data to effectively implement the presently-invented computer-implemented method and system.

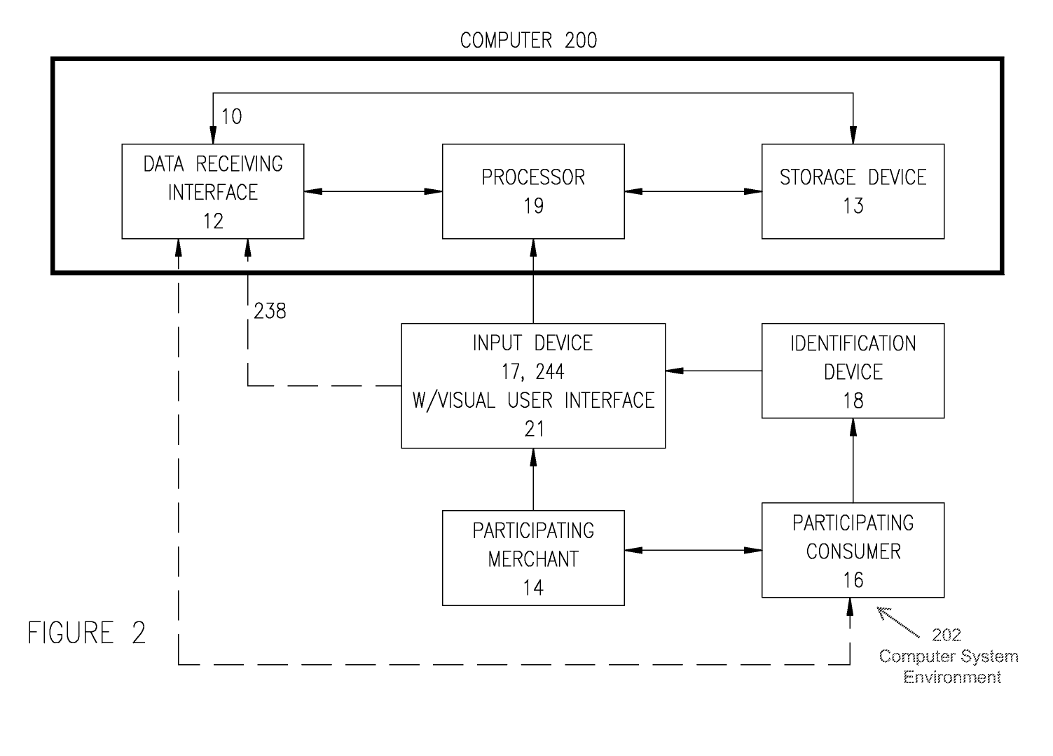

Reference is now made to FIG. 2 which shows the universal rewards system, generally indicated as 10, for consolidating reward and bonus programs for participating merchants 14 across a series of programs in which a consumer 16 participates. An identification device 18 is distributed to the participating consumers 16. This identification device 18 is configured for universal acceptance by each of said participating merchants 14. The universal rewards system 10 consolidates the goods and/or services of a series of participating merchants 14 that can offer diverse goods and/or services to a single identification device 18, eliminating the need for the participating consumers 16 to carry a variety of identification devices. The universal rewards system 10 also provides a platform on which the participating merchants 14 can advertise their flyers, coupons, and/or sales, eliminating the need for printing and/or issuing these sales notices to participating consumers 16, thus promoting a green economy.

Further to the data that is generated and/or collected from the participating merchants 14 or the participating consumers 16, additional data can be associated therewith, whether on a consumer-specific or merchant-specific basis. Accordingly, the system 10 allows for the appropriate generation, identification, collection, storage, and/or analysis of multiple data streams for use in identifying participating merchants, identifying qualified transactions, identifying appropriate rewards/bonuses; and identifying participating consumers and generating data regarding the qualified transactions and the appropriate rewards/bonuses; and then transmitting information regarding the qualified transactions and issuance of the appropriate rewards/bonuses. The system is also capable of providing a paperless advertising platform to the participating merchants 14. Therefore, and in one preferred and non-limiting embodiment, the system 10 represents a central repository and analysis system that can be utilized to effectively track, control, manage, and improve the tracking of consumer spending habits, the issuance of appropriate rewards and bonuses, and the promotion of a green economy through a paperless system.

In addition, the system 10 can be implemented and operated on one or more computers 200, 244 and/or in a computing system environment 202. Accordingly, the data can be derived or generated (as well as communicated) from any component of the universal rewards system 10 in a direct or indirect manner. For example, the operator of the universal rewards system 10 may have the appropriate computer 200 or similar computing device capable of receiving and/or transmitting data, or alternatively, a user, such as a participating merchant 14 or a participating consumer 16 may use an onsite computer 200 or a remote computer 244 to transmit or send this data, normally in a wireless format. However, as discussed hereinafter, any of the components, functions, or features of the presently-invented system 10 can be implemented on one or more computers 200 or computing devices capable of effectively implementing such functions. Therefore, the present invention is not limited to any specific computer 200 or computing system environment 202, such that some or all of the steps, processes, and functions may also be implemented in the network environment 238 (i.e., the “cloud” or software-as-a-service (SaaS) environment).

One preferred and non-limiting embodiment of the present invention is illustrated in FIG. 2. In particular, the system 10 includes a data receiving interface 12 that is configured, adapted, or programmed to directly or indirectly receive data from at least one remote source, such as the user U wherein the user can be the participating merchants 14 or participating consumers 16 and/or a technician T. Further, this received data includes data streams or notifications regarding participating merchants 14, identify qualified transactions, identify appropriate rewards/bonuses; and identify participating consumers 16. The system 10 further includes one or more input devices 17 configured, adapted, or programmed to facilitate the user U input of data. This input device 17 may also be in the form of a computer 200, 244 or computing system environment 202, and may permit the user U to input data in a direct or indirect (wireless) manner. In this embodiment, normally the user U will have certain privileges that are established for use of the various features and functions of the system 10 discussed hereinafter.

With continuing reference to FIG. 2, there is shown a block diagram depicting the universal rewards system, generally illustrated as 10, for consolidating reward and bonus programs across a series of programs in which a consumer 16 participates. The universal rewards system 10 comprises a data receiving interface 12 for organizing and managing the universal rewards system 10. The system 10 includes one or more storage devices 13 that are in direct or indirect communication with the data receiving interface 12 and the input device 17, and such storage devices 13 are configured, adapted, or programmed to store at least a portion of the data received from the data receiving interface 12, at least a portion of the data input by the user and/or process data. Further, the system 10 includes a processor 19 that is in direct or indirect communication with the data receiving interface 12, the input device 17, and the storage device 13. The processor 19, normally in the form of some computing device, computer, server, or the like, is configured, adapted, or programmed to generate a visual user interface 21 for displaying at least a portion of the data received at the data receiving interface 12, at least a portion of the data input by the user (merchant 14 or consumer 16), at least a portion of the data stored in the storage device 13, and/or processed data. The processor 19 is configured to directly or indirectly receive data streams or notifications regarding participating merchants 14, identify qualified transactions, identify appropriate rewards/bonuses; and identify participating consumers 16. The processor 19 can then determine and/or generate data regarding the qualified transactions and the appropriate rewards/bonuses and subsequently transmit this information to the participating merchant 14 so that the merchant 14 can issue the reward/bonus.

An administrator or owner of the universal rewards system 10 charges a participation fee to the various merchants 14 to participate in the universal rewards system 10. One way for collecting the participation fee from the merchant 14 is for the card administrator to charge a minimal swipe fee, such as $0.01-0.02, with each transaction. Each of the various merchants 14 participating in the system 10 can offer a reward or bonus with a qualifying transaction from a participating consumer 16. The various merchants 14 can be any series of merchants which offer a wide variety of diverse goods and/or services. For example, the various merchants 14 can include grocery stores, retail stores, home improvement stores, auto repair shops, restaurants, airlines, hotels, automobile manufactures, or any other type of merchant offering a good and/or service.

With continuing reference to FIG. 2, a single identification device 18 can be issued to a participating consumer 16 that is accepted by all of the participating merchants 14, eliminating the need for the participating consumer 16 to carry an individual identification device 18 for each of the different participating merchants 14. The identification device 18 can include identifying information unique to the participating consumer 16. The identification device 18 is configured for universal acceptance by each of the subscribing merchants 14 and for gathering and/or issuing the reward or bonus with each qualifying transaction by the participating consumer 16. The identification device 18 can comprise a card, a key fob, a phone application, and/or any other type of computer-readable device. Participation by the consumer 16 in the rewards system 10 and receipt of the identification device 18 can require the payment of a participation fee by the consumer 16. This participation fee can be charged to assist the participating merchant 14 in recouping the cost of providing the identification device 18 and/or to offset the costs associated with the consumer's receipt of the particular bonus or reward and/or to help the merchant 14 recoup some of the costs, such as the equipment, i.e., computer 200, 244, input device 17, identification devices 18, required for interacting with the data receiving interface 12 and/or the participation fee paid to the administrator or owner of the universal rewards system 10. Use of the identification device 18 by the consumer 16 can incur a minimal swipe fee associated with each transaction to also help offset the costs to the merchant 14. While the swipe fee may be minimal, such as $0.01 or more, as determined by the merchant 14, charged to the consumer 16 with each transaction, this swipe fee can add up to a significant amount received by the merchant 14, depending upon the volume or amount of transactions that occur. Depending upon the type of scanning equipment owned by the particular merchant 14, modification of the scanning equipment may be necessary. These costs can also be offset by the fees charged to the participating consumer 16.

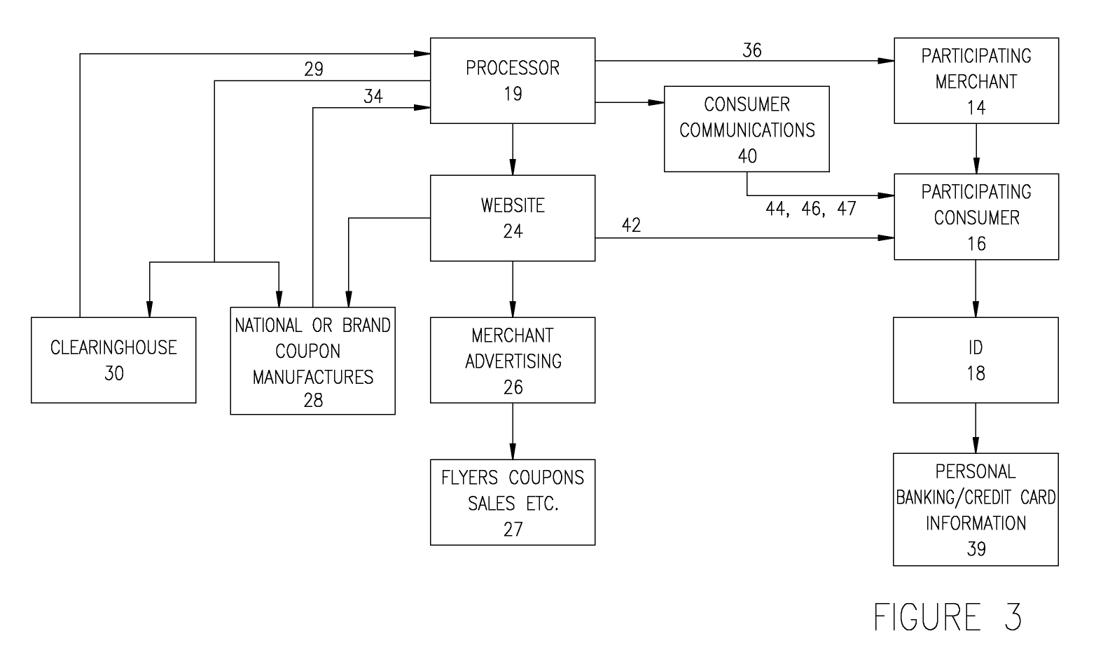

Referring now to FIG. 3, in exchange for payment of the participation fees to participate in the universal rewards system 10 or in exchange for an additional fee, the participating merchants 14 can be granted advertising rights 26 on a website 24 managed by the processor 19. This advertising option will allow the participating merchant 14 to advertise their flyers, coupons, sales, and the like, as shown by 27, eliminating the costs associated with printing and mailing advertisements and promoting a green economy. The participating merchants 14 can also advertise a particular bargain or “deal” as a way to quickly reduce inventory of a particular product. The processor 19 can also have the capability of transacting the sale and shipping the purchase directly to the participating consumer 16. The participating consumers 16 can be provided with access to the website 24 to view the advertisements, sales and coupons 27. According to one embodiment, the processor 19 and website 24 can be tied to national or brand coupon manufacturers 28. The processor 19 can be programmed to automatically tally the coupons and send them, as shown by 29, to the manufacturer or a clearing house 30 for redemption from the manufacturer and to subsequently refund or forward any monies, as shown by 34 and 36, owed to the subscribing merchants 14, for coupons redeemed by participating consumers 16. The universal rewards program 10 can be designed such that use of the identification device 18 results in automatic redemption of any store specials or coupons currently being advertised on the website 24 of the processor 19.

With continuing reference to FIG. 3, according to a further embodiment, the identification device 18 can be linked to the participating consumer's 16 personal credit card information or bank account information 39 so that use of the identification device 18 allows access to the participating consumers 16 account information for automatic payment of a purchased good or item. This would eliminate the need for the participating consumer 16 to carry a separate credit card or bank card. The processor 19 can also include an e-mail, text, social media such as Facebook, and the like, option 40 to enable the participating consumers 16 to receive electronic notification in real time of merchant flyers, coupons, sale notices, and advertisements. The website 24 of the system 10 can also include an option 42 for the participating consumer 16 to directly interface therewith to select or deselect certain subscribing merchants 14 listed on the website 24 to determine which merchants 14 would like to receive the electronic notifications from.

One option that can be accomplished by the system includes the tracking of spending habits of the participating consumers 16 which can then be transmitted to the participating merchants 14 enabling the participating merchant 14 to target or customize their advertising. Another item that can be tracked is the purchase of prescriptions 44 and refill due dates so that an e-mail or text can be automatically sent to the consumer notifying them in real time, that it is time to refill the prescription 44. The universal reward system 10 can transmit information that also allows the participating merchant 14 to automatically track purchases and issue recall notices 46, when necessary, for the purchased items, track automobile maintenance records, and to notify the participating consumer 16 when routine maintenance is due. Yet another option of the universal reward system 10 is the capability of issuing update or upgrade information 47 for any purchased items all in real time.

With continuing reference to FIGS. 2 and 3, the present invention provides a computer-implemented method and apparatus for operating a universal rewards program 10 for consolidating reward and bonus programs across a series of programs in which a consumer participates. The method comprises providing at least one computer 200, such as shown in FIG. 1, having a computer-readable medium with program instructions stored thereon, which, when executed by a processor 19 of the at least one computer 200, causes the processor 19 to directly or indirectly receive data streams or notifications regarding participating merchants 14, identify qualified transactions, identify appropriate rewards/bonuses; and identify participating consumers 16, determine and/or generate data regarding the qualified transactions and the appropriate rewards/bonuses; and transmit information regarding the qualified transactions and issuance of the appropriate rewards/bonuses. The method also includes providing information to the processor 19 wherein the information includes a listing of the participating merchants 14, qualified transactions, appropriate rewards/bonuses and participating consumers 16. The method also includes providing an identification device 18 for distribution to the participating consumers 16 wherein the identification device 18 includes identifying information unique to the participating consumer 16. As stated above, the identification device 18 is configured for universal acceptance by each of the participating merchants 14 and at least some of the participating merchants 14 offer diverse goods and/or services. A participation fee can be charged to the participating merchants 14 and membership dues and swipe fees can be charged to the participating consumers 16 to offset any participation fees and costs associated with the rewards program 10.

The participating merchant 14 can have a computer 244, such as shown in FIG. 1, interconnected with the processor 19 which is capable of providing information to the processor 19 regarding store specials, store flyers, and product and/or service coupons 27 and the processor 19 is configured for transmitting this information to the participating consumers 16. The processor 19 can be configured to receive data from national or brand coupon manufacturers 28, gather and tally information regarding the redeemed coupons 27, transmit this information to the national or brand coupon manufacturers 28 for redemption of any monies owed to the participating merchants 14 for coupons redeemed by participating consumers 16, and transmitting any owed monies to the participating merchants 14. According to the method, use of the identification device 18 results in automatic redemption of any brand manufacturer's coupons 27 participating in the universal reward system 10. The processor 19 can be configured to directly transmit information to participating consumers to enable them to receive electronic notification of merchant flyers, coupons, sale notices, and advertisements 27 from the participating merchants 14 in real time.

The present invention has been described with reference to the preferred embodiments. Obvious modifications and alterations will occur to others upon reading and understanding the preceding detailed description. It is intended that the invention be construed as including all such modifications and alterations.

The invention claimed is:

1. A universal rewards system for consolidating reward and bonus programs across a series of programs in which a consumer participates, said system comprising:
(a) at least one computer having a computer-readable medium with program instructions stored thereon, which, when executed by a processor of the at least one computer, cause the processor to:
(i) directly or indirectly receive data streams or notifications regarding participating merchants, identify qualified transactions, identify appropriate rewards/bonuses, and identify participating consumers;
(ii) determine and/or generate data regarding the qualified transactions and the appropriate rewards/bonuses; and
(iii) transmit information regarding the qualified transactions and issuance of the appropriate rewards/bonuses; and
(b) an identification device for distribution to the participating consumers, said identification device including identifying information unique to the participating consumer, said identification device configured for universal acceptance by each of said participating merchants and wherein at least some of the participating merchants offer diverse goods and/or services.

2. The system of claim 1, wherein the identification device comprises a card, a key fob, or a phone application.

3. The system of claim 1, wherein the identification device includes a participation fee associated therewith.

4. The system of claim 3, wherein the participation fee is charged to the participating consumer and includes membership dues and/or swipe fees associated with each transaction in order to credit or redeem any reward or bonus.

5. The system of claim 1, wherein the participating merchants communicate with the processor via a computer interconnected to the processor for providing data streams to the processor, and the processor is capable of transmitting information to the participating consumers.

6. The system of claim 5, wherein the data streams include advertising information including merchant flyers and coupons, and the processor is configured for communicating this advertising information to the participating consumers.

7. The system of claim 6, wherein use of the identification device results in automatic redemption of any store specials or coupons currently advertised.

8. The system of claim 1, wherein the processor is tied to national or brand coupon manufacturers and is capable of receiving data streams regarding coupons and specials offered by the national or brand coupon manufacturers.

9. The system of claim 8, wherein the processor is capable of automatically tallying the discounts due to participating merchants for these coupons and specials, transmitting this information to the manufacturer or a clearing house for redemption from the manufacturer, and transmitting any monies owed to the participating merchants for coupons redeemed by participating consumers.

10. The system of claim 8, wherein the national or brand coupon manufacturer pays a fee to advertise on a website associated with the processor and each participating merchant receives advertising media for a particular item for which a coupon or discount is available.

11. The system of claim 8, wherein use of the identification device results in automatic redemption to the consumer of any brand manufacturer's coupons participating in the universal reward system.

12. The system of claim 1, wherein the identification device is linked to a participating consumer's credit card or bank account information so that use of the identification device allows access to the participating consumers account information for automatic payment of a purchased good or item.

13. The system of claim 1, wherein the processor is configured to directly transmit information to participating consumers to enable them to receive electronic notification of merchant flyers, coupons, sale notices, and advertisements from participating merchants.

14. The system of claim 13, wherein the participating consumers are capable of communicating with the processor to select or deselect certain participating merchants from which to receive the electronic notifications.

15. The system of claim 13, wherein the processor enables a merchant's computer to determine and/or generate data regarding spending habits of the participating consumer for targeted advertising, determine and/or generate data purchased prescriptions and refill due dates, determine and/or generate data regarding recall notices on purchased items in real time, and determine and/or generate data regarding update information for any purchased items.

16. A computer-implemented method for a universal rewards program for consolidating reward and bonus programs across a series of programs in which a consumer participates, said method comprising:
(a) providing at least one computer having a computer-readable medium with program instructions stored thereon, which, when executed by a processor of the at least one computer, cause the processor to:
(i) directly or indirectly receive data streams or notifications regarding participating merchants, identify qualified transactions, identify appropriate rewards/bonuses, and identify participating consumers;
(ii) determine and/or generate data regarding the qualified transactions and the appropriate rewards/bonuses; and
(iii) transmit information regarding the qualified transactions and issuance of the appropriate rewards/bonuses;
(b) providing information to said processor, said information including participating merchants, qualified transactions, appropriate rewards/bonuses and participating consumers; and
(c) providing an identification device for distribution to the participating consumers, said identification device including identifying information unique to the participating consumer, said identification device configured for universal acceptance by each of said participating merchants and, wherein at least some of the participating merchants offer diverse goods and/or services.

17. The method of claim 16, including charging a participation fee to the participating merchants and charging membership dues and swipe fees to the participating consumers to offset any participation fees and costs associated with the rewards program.

18. The method of claim 16, wherein the merchant has a computer interconnected with the processor which is capable of providing information to the processor regarding store specials, store flyers, and product and/or service coupons, and the processor is configured for transmitting this information to the participating consumers.

19. The method of claim 18, wherein the processor is configured to receive data from national or brand coupon manufacturers, gather and tally information regarding the redeemed coupons, transmit this information to the national or brand coupon manufacturers for redemption of any monies owed to the participating merchants for coupons redeemed by participating consumers, and transmitting any owed monies to the participating merchants and, wherein use of the identification device results in automatic redemption of any brand manufacturer's coupons participating in the universal reward system.

20. The method of claim 19, wherein the processor is configured to directly transmit information to participating consumers to enable them to receive electronic notification of merchant flyers, coupons, sale notices, and advertisements from participating merchants.

21. An apparatus for operating a universal rewards program for consolidating reward and bonus programs across a series of programs in which a consumer participates, said apparatus comprising:
(a) at least one computer having a computer-readable medium with program instructions stored thereon, which, when executed by a processor of the at least one computer, cause the processor to:
(i) directly or indirectly receive data streams or notifications regarding participating merchants, identify qualified transactions, identify appropriate rewards/bonuses, and identify participating consumers;
(ii) determine and/or generate data regarding the qualified transactions and the appropriate rewards/bonuses; and
(iii) transmit information regarding the qualified transactions and issuance of the appropriate rewards/bonuses;
(b) means for providing information to said processor, said information including participating merchants, qualified transactions, appropriate rewards/bonuses and participating consumers; and
(c) an identification device for distribution to the participating consumers, said identification device including identifying information unique to the participating consumer, said identification device configured for universal acceptance by each of said participating merchants and, wherein at least some of the participating merchants offer diverse goods and/or services.
